(19) United States
(12) Patent Application Publication
(10) Pub. No.: US 2019/0024450 A1
(43) Pub. Date: Jan. 24, 2019

(54) QUICK RELEASE IDLE END FOR A ROLLER BLIND

(71) Applicant: ZMC Metal Coating Inc., Woodbridge (CA)

(72) Inventor: Philip Ng, Thornhill (CA)

(73) Assignee: ZMC Metal Coating Inc., Woodbridge (CA)

(21) Appl. No.: 15/974,177

(22) Filed: May 8, 2018

Related U.S. Application Data
(60) Provisional application No. 62/535,273, filed on Jul. 21, 2017.

(51) Int. Cl. E06B 9/42

(52) U.S. Cl. CPC E06B 9/42

(57) ABSTRACT

An idle end for a roller blind, the idle end comprising a housing that includes a roller tube engagement portion for securing said housing to an end of a roller tube, and a pin. The pin comprises a body portion slidably receivable within said housing and extending outwardly from an end of said housing and terminating at an end face, said body portion having a notch that is shaped to receive a tool to permit the tool to engage the body portion and force the pin to slide relative to the housing, and a mounting element extending from said end face, said mounting element releasably securable to an idle end bracket of the roller blind to secure the end of the roller tube to the idle end bracket.

### CROSS-REFERENCE TO RELATED APPLICATIONS

This patent application claims priority on and the benefit of U.S. Provisional Patent Application No. 62/535,273 having a filing date of 21 Jul. 2017.

### BACKGROUND OF THE INVENTION

### Technical Field

This invention relates generally to rollers blinds or shades, and in particular to an idle end for a roller blind.

### Prior Art

Roller blinds are a popular method to limit the intrusion of light through a window or other opening. Roller blinds can also be useful when positioned about a window for thermal and sound insulating purposes.

Roller blinds are typically comprised of a fabric or similar material wound about a roller tube. The roller tube is suspended between two end brackets that are mounted on or about a window frame. Commonly, one of the end brackets houses or has otherwise associated with it the blind's primary drive mechanism (which may include a return spring, clutch, etc.). The other or opposite end bracket typically receives an idle end which serves to support the end of the roller blind.

The idle end is often fitted with a retractable pin that may be received within a slot or hole in its related end bracket. The pin serves to “hang” the roller tube from the end bracket that is opposite to the clutch.

When mounted to its end bracket, it is often desirable for the idle end to be coupled as close as possible to the end bracket so that only a small gap is formed between the blind fabric and the window frame. This helps to limit the intrusion of light through the window and improves a covering's thermal and sound insulating capacity. However, where the resulting space between the idle end and its corresponding end bracket is narrow, removing of the roller tube from the end bracket can be difficult. Typically, a tool, such as a screwdriver or knife, is inserted between the idle end and corresponding bracket and forced against the side of the pin, often marking, scoring or indenting the pin, in an attempt to slide the pin sideways to force the pin out of the hole in the end bracket. With little room in which to work, withdrawing the pin from within the hole in the related end bracket can be time consuming and difficult.

### BRIEF SUMMARY OF THE INVENTION

The invention provides an idle end for a roller blind, the idle end comprising a housing that includes a roller tube engagement portion for securing said housing to an end of a roller tube, and a pin. The pin comprises a body portion slidably receivable within said housing and extending outwardly from an end of said housing and terminating at an end face, said body portion having a notch that is shaped to receive a tool to permit the tool to engage the body portion and force the pin to slide relative to the housing, and a mounting element extending from said end face, said mounting element releasably securable to an idle end bracket of the roller blind to secure the end of the roller tube to the idle end bracket.

Further aspects of the invention will become apparent from the following description taken together with the accompanying drawings.

### BRIEF DESCRIPTION OF THE DRAWINGS

For a better understanding of the present invention, and to show more clearly how it may be carried into effect, reference will now be made, by way of example, to the accompanying drawings which show exemplary embodiments of the present invention in which:

FIG. 1 is an upper perspective view of a typical roller blind employing an idle end in accordance with an embodiment of the invention.

FIG. 2 is a partially exploded view of the roller blind shown in FIG. 1, with the idle end detached from its end bracket.

FIG. 3a is an upper side perspective view of the idle end of FIG. 2.

FIG. 3b is a plan view of the idle end of FIG. 3a.

FIG. 4a is an upper side perspective view of an idle end according to a second embodiment of the invention.

FIG. 4b is a plan view of the idle end of FIG. 4a.

FIG. 5a is an upper side perspective view of an idle end according to a third embodiment of the invention.

FIG. 5b is a plan view of the idle end of FIG. 5a.

FIG. 6a is an upper side perspective view of an idle end according to a fourth embodiment of the invention.

FIG. 6b is a plan view of the idle end of FIG. 6a.

FIG. 7 is a front view of the roller blind shown in FIG. 1, with a tool engaging the idle end to remove the idle end from its end bracket.

FIG. 8 is an enlarged view of portion 8-8 of FIG. 7.

FIG. 9 is a view similar to FIG. 8 where the pin of the idle end has been retracted by the tool.

### DETAILED DESCRIPTION OF THE INVENTION

The present invention may be embodied in a number of different forms. The specification and drawings that follow describe and disclose some of the specific forms of the invention.

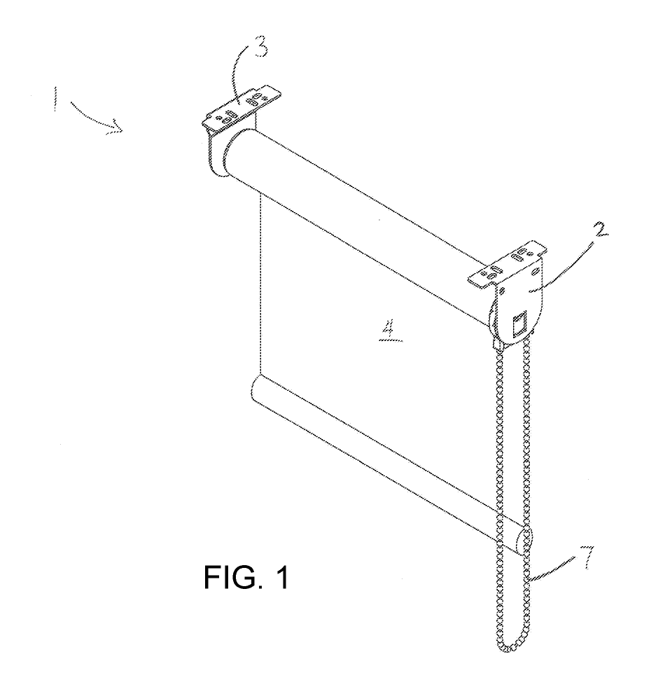

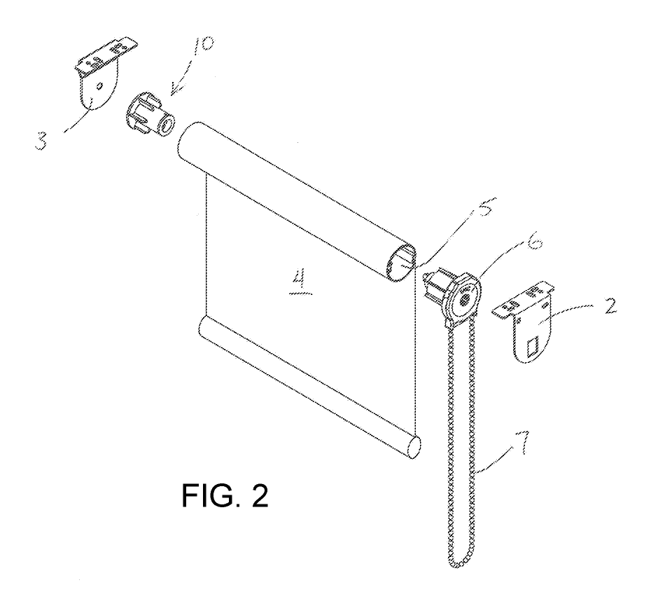

FIG. 1 shows, in front elevation, a relatively standard roller blind 1 that is mounted to a surface through the use of a clutch end bracket 2 and an idle end bracket 3. Blind fabric 4 is received about a roller tube 5 and is wound or unwound from the roller tube through the operation of a clutch 6 which is activated by a chain or cord 7. The opposite end of the roller tube includes an idle end 10 (see FIG. 2) that is secured to the roller tube, and that generally serves to hang or secure the end of the roller tube, opposite the clutch, to its corresponding idle end bracket 3. It will be appreciated by those of skill in the art that idle ends for roller blinds generally serve the purpose of “hanging” one end of a blind from an end bracket, while permitting the roller tube to rotate.

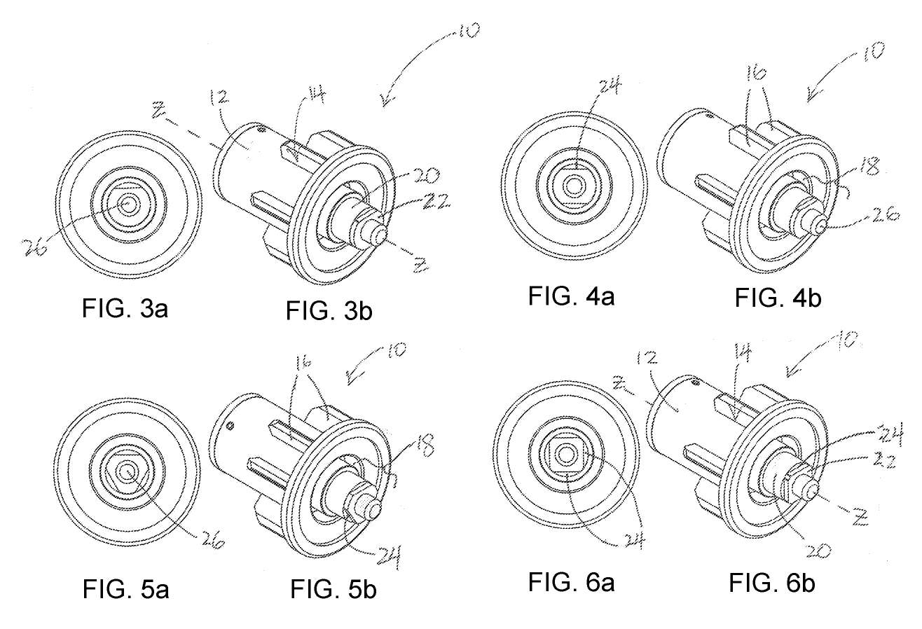

With reference to FIGS. 3a through 6b, idle end 10 includes a housing 12, with a longitudinal axis Z. Housing 12 includes a roller tube engagement portion 14 that secures the housing to the end of roller tube 5. In the particular embodiments depicted in the attached drawings, roller tube engagement portion 14 comprises a series of longitudinally oriented splines 16 that frictionally engage the interior surface of the roller tube when the housing is inserted therein. In so doing, splines 16, and the portion of housing 12 to which they are attached, effectively become fixed to the roller tube and rotate with it.

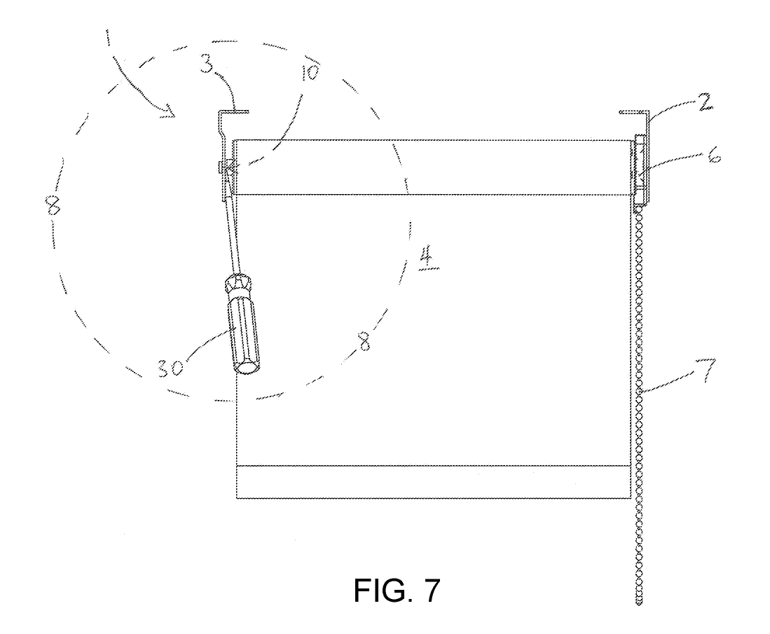

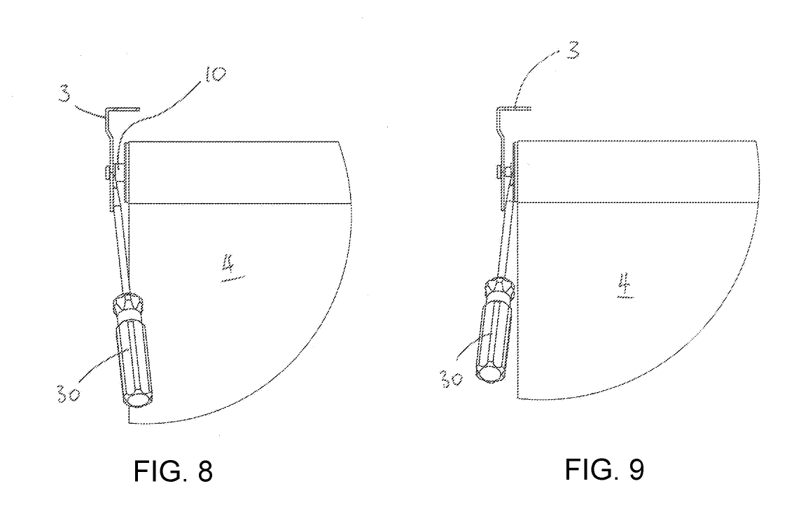

To permit idle end 10 (and hence the end of the roller tube to which the idle end is secured) to be hung from idle end bracket 3, idle end 10 includes a pin 18. Pin 18 includes a body portion 20 which is slidably receivable within housing 12 and extends outwardly from an end of housing 12. In most instances it is expected that pin 18 will have a longitudinal axis that is co-axial with axis Z of housing 12. As shown, body portion 20 terminates at an end face 22. Body portion 20 also has at least one notch 24 that is shaped to receive a tool 100 (see FIGS. 7-9) to permit the tool to engage the body portion to force the pin to slide relative to the housing.

In the depicted embodiment, notch 24 is orientated substantially perpendicular to longitudinal axis Z of housing 12. This facilitates sliding movement of pin 18 in a direction generally parallel to longitudinal axis Z of housing 12 through use of the tool.

Notch 24 is further shown to be positioned adjacent end face 22. Positioning notch 24 adjacent end face 22 allows the tool to slide pin 18 through a greater distance towards housing 12.

As will be readily understood from FIGS. 3a through 6b, body portion 20 may include multiple notches 24 circumferentially spaced about end face 22. FIGS. 3a and 3b show idle end 10 with one notch. FIGS. 4a and 4b show idle end 10 with two notches. FIGS. 5a and 5b show idle end 10 with three notches. FIGS. 6a and 6b show idle end 10 with four notches circumferentially spaced about end face 22.

Pin 18 further comprises a mounting element 26 which extends from end face 22. Mounting element 26 is releasably securable to idle end bracket 3 of the roller blind to secure the end of the roller tube to the idle end bracket. In the example embodiments, mounting element 26 is configured to be inserted into a correspondingly shaped hole in idle end bracket 3.

In one preferred embodiment, idle end 10 includes a biasing member (not shown) within housing 12 for biasing pin 18 to extend outwardly from the end of housing 12. Such a biasing member may be a spring or one of a variety of mechanisms that bias pin 18 outwardly and away from housing 12.

With reference to FIGS. 7 through 9, there is shown roller blind 1 with a tool 30 (in this instance, a screwdriver), engaging idle end 10 to remove idle end 10 from idle end bracket 3.

Notch(es) 24 on idle end 10 provide an engaging surface against which the end of tool 30 may be received in order to permit pin 18 to be slid out of the hole in idle end bracket 3. In this manner, tool 30 may engage any one of notches 24 to allow an individual to retract pin 18 into housing 12. Idle end 10, and hence roller tube 5, may then be removed or disengaged from idle end bracket 3.

While tool 30 is shown in the figures to be a screwdriver, a skilled person would understand that any one of a variety of tools may be used to engage idle end 10 in the manner described above.

The scope of the claims should not be limited by the preferred embodiments set forth in the examples, but should be given the broadest interpretation consistent with the description as a whole.

I claim:

1. An idle end for a roller blind, the idle end comprising:
a housing that includes a roller tube engagement portion for securing said housing to an end of a roller tube; and
a pin comprising:
a body portion slidably receivable within said housing and extending outwardly from an end of said housing and terminating at an end face, said body portion having a notch that is shaped to receive a tool to permit the tool to engage the body portion and force the pin to slide relative to the housing; and
a mounting element extending from said end face, said mounting element releasably securable to an idle end bracket of the roller blind to secure the end of the roller tube to the idle end bracket.

2. The idle end as claimed in claim 1, wherein the notch is orientated substantially perpendicular to a longitudinal axis of the housing, facilitating sliding movement of the pin generally parallel to the longitudinal axis of the housing through use of the tool.

3. The idle end as claimed in claim 2, wherein the notch is positioned adjacent said end face.

4. The idle end as claimed in claim 3, wherein said body portion includes multiple notches circumferentially spaced about said end face.

5. The idle end as claimed in claim 4, further comprising a biasing member within the housing for biasing the pin to extend outwardly from said end of said housing.
